(19) United States
(12) Patent Application Publication
(10) Pub. No.: US 2024/0021080 A1
(43) Pub. Date: Jan. 18, 2024

(54) COMMUNICATION SYSTEM FOR ROAD SIGNAGE AND METHOD FOR PRODUCING A ROAD SIGNAGE COMMUNICATION SYSTEM

(71) Applicant: MTSYS S.R.L., Comezzano-Cizzago (Brescia) (IT)

(72) Inventors: Paolo FILIPPI, Piancogno (Brescia) (IT); Marco LANCINI, Adro (Brescia) (IT)

(21) Appl. No.: 18/249,116

(22) PCT Filed: Jun. 22, 2021
(86) PCT No.: PCT/IB2021/055476

§ 371 Date: Apr. 14, 2023

(30) Foreign Application Priority Data
Oct. 16, 2020 (IT) 102020000024412

(51) Int. Cl. G08G 1/0962; G08G 1/0967

(52) U.S. Cl. CPC G08G 1/09623; G08G 1/096783

(57) ABSTRACT

A communication system for road signage and a respective production method, applicable to horizontal or vertical signage, which includes at least one electronic device for acquiring and sending data, applied irremovably to a portion of a respective road signage; and a coupling support associated with the electronic device and configured to be engaged to said portion of a respective signage.

The present invention relates to a communication system for road signage, in particular a real-time communication system which allows the exchange of information from a vehicle by radio frequency. The present invention also relates to a method for producing the communication system capable of being associated with any type of horizontal or vertical signage.

As is known, road traffic is regulated by appropriate signage used to signal risks/dangers or to regulate the circulation of vehicles. Road signage is also used for information or advertising purposes, to convey promotional messages or other road indications or indications related to the territory surrounding the signage.

The road signage may be horizontal, applied directly to the road surface, or vertical, positioned on the sides or above the roadway.

Horizontal signage, generally designed to maintain a high level of road safety and to ensure the safety of the passengers of vehicles circulating thereon, consists of a series of drawings and lines obtained by distributing a covering paint or other similar material on the road surface. Generally, the paint is distributed in liquid form and according to hot or cold methods. Furthermore, the paint contains a glass powder which allows a high level of light refraction, thus increasing the visibility thereof.

Vertical signage consists of one or more signs on which the graphic representation of the sign or informative message is shown. The signs are suitably supported by poles extending on the sides of the roadway or above the roadway itself. Again, the figure depicted on the signage is made with materials with a high refractive coefficient to make the figure clearly visible. Vertical signage can also consist of electronic panels which, like those described above, give useful indications to users for the correct use of the infrastructure. The panels described are called variable message panels.

In order to ensure the continuous functionality of road signage, both ordinary (normal wear and tear) and extraordinary (damage resulting from road accidents or particular weather events) maintenance operations are carried out.

In this context, the maintenance interventions are programmed based on a monitoring of the condition of the signage aimed at identifying wear/damage conditions.

For example, in the case of horizontal signage (limit and intra-roadway lines, precedence signs, stops, arrows, etc.) the level of wear of the glass dust is constantly monitored by measuring the respective refractive coefficient with appropriate instruments.

Thereby, the degradation level of one or more parts of the signage is identified and then communicated to the service manager by means of photographic data and surveys detected by documentary means.

However, the system for monitoring and scheduling maintenance has a major drawback derived from the necessary document reporting procedure (photographs and reports) which must be produced and archived with the consequent expenditure in terms of resources, time and economy. Moreover, the document collection process is not free from human errors and communication delays which cause considerable problems in the proper functioning of the road network.

In view of the drawbacks highlighted, the object of the present invention is to improve or overcome one or more aspects of the prior art techniques.

Another object of the present invention is to provide a road signage communication system capable of automating maintenance processes, in particular those of mapping the condition of the signage, in order to make the execution of the works necessary for safeguarding the road network faster and more effective.

Another object is to provide a communication system which allows the identification and tracking of road signage.

This is achieved by making the signage itself able to acquire information (e.g., the level of light refraction) and make it available to the external environment (e.g., to the company managing the maintenance of the lines).

A further object of the present invention is to provide a method for producing the communication system which is applicable to any type of signage, whether horizontal or vertical, intended for cars, scooters, bicycles and pedestrians.

A further object of the present invention is to provide a method for producing road signage which is simple in the application thereof, low cost, and capable of maintaining the original structure of the signage itself.

The present invention relates to a road signage communication system as defined in the appended claim 1 and by the preferred embodiments thereof indicated in the dependent claims 2 to 7.

The object of the present invention is also a method for producing the road signage communication system as defined in the appended claim 8 and in the embodiments described in the dependent claims 9 to 12.

The Applicant has perceived that the system and method object of the present invention for the real-time identification and tracking according to the present invention have the following advantages:
allow the detection and monitoring of the state of wear of the signage quickly, without the need for the collection and sending of documentation;
allows to track certified information with a guaranteed service level;
allows the exchange of any type of information to vehicles or other devices for reading a signal transmitted by radio frequency;
does not alter the structure and proper functioning of the signage.

Additional features and advantages of the invention will become more apparent from the description which follows of a preferred embodiment and the variants thereof, provided by way of example with reference to the appended drawings, in which:

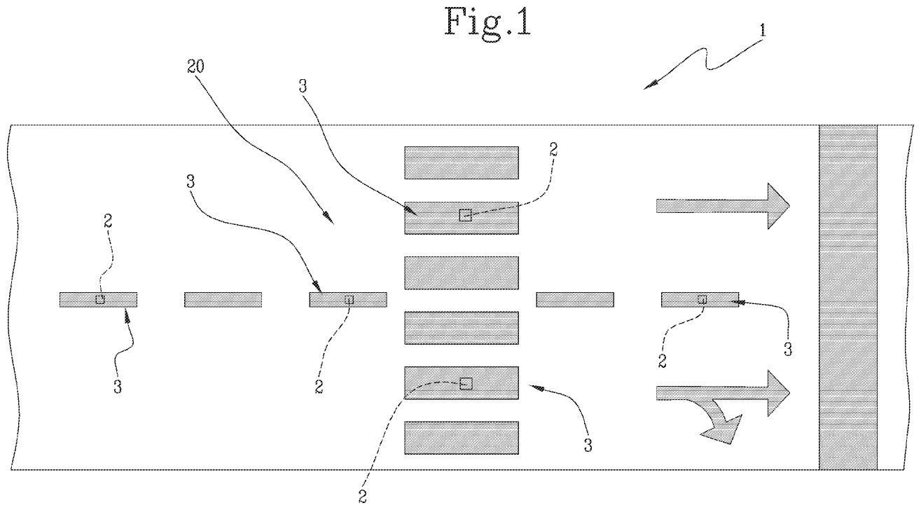

FIG. 1 shows a schematic view of a horizontal signage which incorporates the communication system according to the present invention;

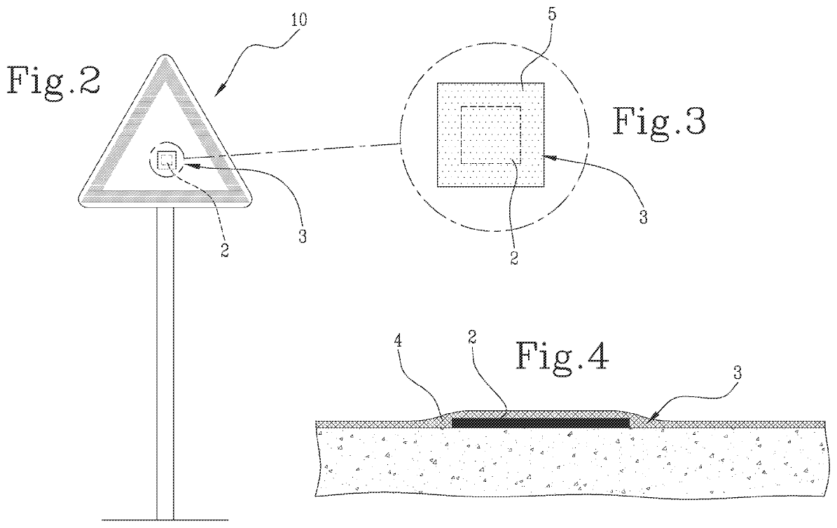

FIG. 2 shows a schematic view of a vertical signage which incorporates the communication system according to the present invention;

FIG. 3 shows a detail of the communication system of FIG. 2;

FIG. 4 shows a sectional view of a detail of the communication system of FIG. 1;

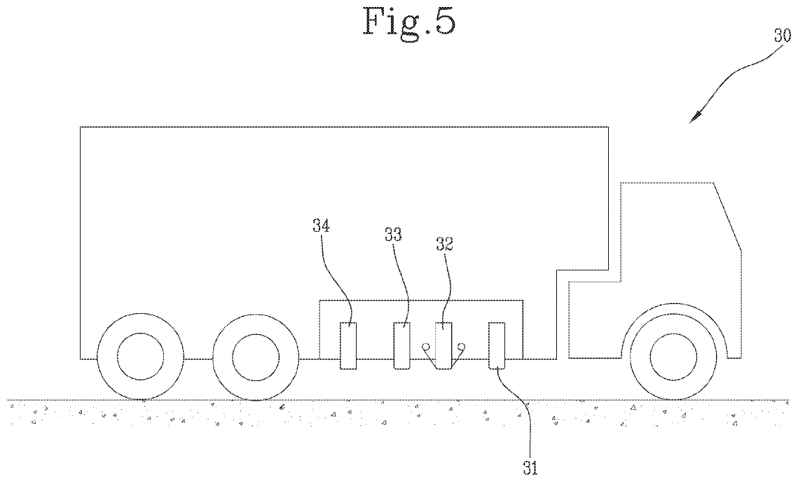

FIG. 5 is a schematic view of a vehicle realizing the communication system.

With reference to the aforementioned figures, the communication system for road signage according to the invention is generally indicated with the reference numeral 1.

It should be specified that the system and the relative production method is applicable to vertical signage 10 or horizontal signage 20 of any type and intended for both vehicles and pedestrians.

In particular, the system comprises an electronic device 2 for acquiring and sending data, applied irremovably to a respective road signage.

The device 2 preferably comprises a radio frequency transceiver of limited size to be incorporated within the signage.

Advantageously, the device 2 is an RFID tag.

Furthermore, the system comprises a plurality of devices 2 located along the road signage and suitably spaced apart.

In particular, each device 2 is irremovably positioned in a specific area of the signage as a function of the specific function thereof or as a function of specific areas to be monitored. Furthermore, the position of the devices 2 along the signage can be determined to provide specific information to a reader e.g., placed on a vehicle based on the surrounding environment.

However, it should be specified that the number of devices 2 used and the position thereof can be any according to the type of communication and the purpose for which such communication is implemented (monitoring and maintenance, road information, advertising information, etc.).

The system 1 comprises a coupling support 3 of the aforementioned electronic device 2.

In accordance with a first embodiment illustrated in FIGS. 1 and 4, in which the system 1 is applied to a horizontal signage 20, the coupling support 3 comprises a layer 4 preferably of thermoplastic material incorporating the device 2 and arranged above the road surface.

In particular, as better illustrated in the sectional view of FIG. 4, the layer 4 defines the design of the horizontal signage and has predefined shapes according to the type of signage. For example, the layer 4 can be in the form of a rectangular line to define pedestrian crossings or continuous/discontinuous roadway division lines, indication arrows, or other indicative text.

The layer 4 is deposited directly on the road surface or on a pre-existing layer which must be covered, as it is damaged or worn. The pre-existing layer (not shown in the accompanying figures) can be made of the same thermoplastic material as the layer 4 or other type of material (paint).

The device 2 is then covered by the layer 4, thus remaining out of sight and positioned between the layer 4 itself and the road surface/pre-existing signage layer.

In addition, the layer 4 may be of any other type of material to which glass powder or other system is eventually added to allow the refraction of light.

In accordance with a second embodiment illustrated in FIGS. 2 and 3, the system is applied to a vertical signage 10.

In this case, the coupling support 3 is in the form of an adhesive film 5, capable of incorporating the device 2 and configured to offer a gluing surface to a road sign. As illustrated by way of example in FIG. 2, the adhesive is glued to the back of a sign. However, the coupling position can be any as a function of the specific forms of the vertical signage and as a function of the specific needs. For example, the adhesive 5 may be positioned on the back or frame of the sign as well as on the pole or frame in the case of portal bearing structures.

Advantageously, the application of RFID tags makes the signage itself, vertical and/or horizontal, capable of acquiring information and making it available to the external environment.

Preferably, such information is recorded and stored on an external cloud/server and is associated with a unique code representative of the RFID tag. In other words, each tag is assigned a respective code uniquely associated with respective information. Thereby, by reading each code (sent by the RFID tag) it is possible to access and possibly update the information connected thereto.

Alternatively, the system 1 can for example be provided with writing equipment (not illustrated in the accompanying figures), adapted to record data in the individual RFIDs which in turn are read by special reading equipment (also not illustrated, as of known type) for example installed on vehicles. In this case the tag is provided with an internal memory for recording data.

Advantageously, the system 1 is capable of communicating with one or more reading devices, making the various data sending processes automatic.

The present invention further relates to a method for producing the communication system 1.

The method comprises the steps of preparing an electronic device 2 for acquiring and sending data of the type described above and irremovably associating the device 2 with a coupling support 3.

The coupling support 3 is in turn engaged to at least one portion of a horizontal 20 or vertical 10 signage.

In particular, in the case of horizontal signage 20, the step of associating the device 2 to the support 3 is implemented by positioning the device 2 on the road surface or as specified above on the pre-existing signage which must be covered, as it is damaged/worn. Thereafter, the thermoplastic material layer 4 is distributed above the device 2.

Such a step of distributing the layer 4 is preferably actuated hot, heating the material to a temperature adapted to render the material itself in liquid form. In this manner, the layer 4 in liquid form is deposited laminated or sprayed on the device 2 (and on the road surface).

Advantageously, with the hot painting technique, the thermoplastic material forming the layer 4 is heated to a temperature of 200° C. Furthermore, the RFID tag is specially configured to withstand the application temperatures of the thermoplastic material and thus at temperatures of about 200° C.

Thereafter, the layer 4 is cooled to room temperature to return to the solid layer and therefore internally incorporate the aforesaid device 2. Such a process is actuated by depositing a plurality of devices 2 and then covering the devices 2 with one or more layers 4 which form the horizontal signage 20.

According to a preferred embodiment of the present invention, the method for producing the communication system 1 for horizontal signage 20 is implemented by a vehicle 30 schematically illustrated in FIG. 5.

The vehicle 30 is provided with a tank with the thermoplastic material to be applied by laminate or spray therein and delivery systems controlled from inside the vehicle.

A reader 31 is provided facing the road and adapted to verify that there is not already an RFID tag applied to the road surface.

Next to the reader 31 and downstream thereof with respect to the advancement direction of the vehicle 30, an automatic applicator 32 is provided, for example of the buffer type or roller type or other equivalent technology, and configured to deposit the respective electronic devices 2 in series on the road surface.

Next to and downstream of the applicator 32, a reader 33 is provided for initializing and recording the RFID tag just applied to the ground.

Finally, downstream of the reader 33, the delivery system 34 of the thermoplastic layer 4 is provided, which as specified above provides for the hot deposition, laminate or spray, of the material itself.

According to an alternative methodology, the devices 2 can be deposited manually. In this case, once the tag is deposited, the layer is cold deposited and then manually heated with portable flame.

Advantageously, once the device 2 has been applied and appropriately activated, the signage layer 4 is deposited above the device 2 itself, still allowing radio frequency communication.

Advantageously, it should be noted that the device 2 is capable of communicating (receiving and sending signals) even at a distance of a few metres with passages at speeds of several tens of km/h.

With regard to vertical signage 10, the step of associating the device 2 with the support 3 is actuated by coupling the RFID tag to the adhesive film 5 (FIG. 3).

Thereby, the film 5 irremovably supports and is in turn coupled to a surface of a respective signage.

Advantageously, the adhesive nature of the film 5 and the dimensions of the device 2 allow the RFID tag to be applied to any type of vertical signage and anywhere in the signage.

The communication system described above and the relative production method solve the drawbacks of the prior art and bring considerable advantages.

Firstly, the application of RFID tags on both horizontal and vertical signage allows to make the signage itself capable of acquiring information, such as the state of wear of the signage, and make it available by means of the passage of a reader, for example by the road maintenance company.

Advantageously, all documentation collection, sending and archiving procedures are eliminated, with considerable advantages in terms of time, communication efficiency and therefore economic terms.

Furthermore, the RFID is constantly updated both on the level of wear and on the execution of maintenance work and, in the case of new installations, on the progress of the work.

A further important advantage is the possibility of registering any type of information and making it available as a function of the various needs. For example, the road network may interact with a reader mounted on vehicles to send advertising information or other content related to the road or surrounding environment.

Moreover, the communication system production method is particularly simple, affordable and does not interfere with the normal structure and operation of any type of road signage.

1. Communication system for road signage, characterized in that it comprises:
at least one electronic device for acquiring and sending data, applied irremovably to a portion of a respective road signage; and
a coupling support associated with the electronic device and configured to be engaged to said portion of a respective signage.

2. System according to claim 1, wherein said electronic device comprises a radio frequency transceiver, preferably an RFID tag.

3. System according to claim 1, wherein it comprises a plurality of devices located along the road signage and suitably spaced apart from each other.

4. System according to claim 1, wherein said device is configured to store data and to transfer data to a respective reader.

5. System according to claim 1, wherein said device is configured to record a unique code associable with a respective information stored on the cloud or other server.

6. System according to claim 1, wherein the coupling support comprises a layer made of thermoplastic material configured to incorporate the device and to be arranged above the road surface.

7. System according to claim 6, wherein the layer defines the design of the horizontal signage and in which the device is interposed between the road surface and said layer.

8. System according to claim 1, wherein the coupling support comprises an adhesive film incorporating the device.

9. System according to claim 8, wherein the adhesive film has a gluing surface configured to be engaged to a road sign.

10. Method for producing a road signage communication system of the type described in claim 1, comprising the steps of:
preparing at least one electronic device for acquiring and sending data; and
immovably associating the device with a coupling support;
wherein the step of associating the device with the support is implemented by positioning the device on the road surface or on pre-existing signage and subsequently distributing a layer above the device itself.

11. Method according to claim 10, wherein the step of distributing the layer is carried out by heating a thermoplastic material to a temperature adapted to render the material itself in liquid form.

12. Method according to claim 11, wherein the layer in liquid form is distributed laminated or sprayed on the device and on the road surface.

13. Method according to claim 10, wherein after the layer distribution step, it comprises the step of cooling the thermoplastic material to present a solid structure incorporating said device.

14. Method according to claim 10, wherein a plurality of devices are positioned, each of which is covered with a respective layer; said layers forming a horizontal signage.
